(19) United States
(12) Patent Application Publication
(10) Pub. No.: US 2019/0258245 A1
(43) Pub. Date: Aug. 22, 2019

(54) VEHICLE REMOTE OPERATION DEVICE, VEHICLE REMOTE OPERATION SYSTEM AND VEHICLE REMOTE OPERATION METHOD

(71) Applicant: DENSO TEN Limited, Kobe-shi (JP)

(72) Inventors: Masashi NAKAMURA, Kobe-shi (JP); Masanori KOBAYASHI, Kobe-shi (JP); Kouichi MURAMATSU, Kobe-shi (JP); Hideki NOJIMA, Kobe-shi (JP); Minoru MAEHATA, Kobe-shi (JP)

(73) Assignee: DENSO TEN Limited, Kobe-shi (JP)

(21) Appl. No.: 16/227,261

(22) Filed: Dec. 20, 2018

(30) Foreign Application Priority Data
Feb. 19, 2018 (JP) 2018-027158

(51) Int. Cl. G05D 1/00; G05D 1/02

(52) U.S. Cl. CPC G05D 1/0038; G05D 1/0246; G05D 1/0044

(57) ABSTRACT

A vehicle remote operation device includes: a communication unit configured to receive a composite image, which is to be generated on the basis of plural captured images captured at each of plural in-vehicle cameras mounted to a vehicle and shows a surrounding area of the vehicle seen from a virtual view point; a display configured to display the composite image; an operation unit for operating the vehicle, and a signal generation unit configured to generate a control signal of the vehicle, based on an operation on the operation unit. The display is configured to display the composite image having an image of the operation unit superimposed thereon and an auxiliary image comprising a state of the vehicle.

### CROSS-REFERENCE TO RELATED APPLICATIONS

This application is based on and claims priority under 35 USC 119 from Japanese Patent Application No. 2018-27158 filed on Feb. 19, 2018.

### BACKGROUND

### Technical Field

The present disclosure relates to a vehicle remote operation device, a vehicle remote operation system and a vehicle remote operation method.

### Related Art

In recent years, a variety of technologies have been suggested with respect to a remote operation of a vehicle. For example, a portable terminal suggested in Patent Literature 1 is a terminal for moving a vehicle from a first predetermined position to a second predetermined position. The portable terminal is configured to display an aerial image, which includes an image of the vehicle, based on a capture image captured by a camera thereof, and to receive a user's operation on the vehicle. Also, for example, a parking assistance device suggested in Patent Literature 2 enables parking by using a remote operation means such as a joystick. Also, for example, a vehicle remote operation system suggested in Patent Literature 3 includes a portable terminal configured to transmit an operation signal, which corresponds to a touch operation on a touch panel, to a vehicle. The portable terminal can transmit a traveling operation signal and a steering operation signal to the vehicle.

Patent Literature 1: JP-A-2014-65392

Patent Literature 2: JP-A-2010-95027

Patent Literature 3: JP-A-2016-74285

### SUMMARY

However, the relate art cannot sufficiently satisfy convenience and operability of the vehicle remote operation.

It is therefore an object of the disclosure to provide a technology capable of improving convenience and operability of a vehicle remote operation.

According to an aspect of the present disclosure, there is provided a vehicle remote operation device including: a communication unit configured to receive a composite image, which is to be generated on the basis of plural captured images captured at each of plural in-vehicle cameras mounted to a vehicle and shows a surrounding area of the vehicle seen from a virtual view point; a display configured to display the composite image; an operation unit for operating the vehicle, and a signal generation unit configured to generate a control signal of the vehicle, based on an operation on the operation unit. The display is configured to display the composite image having an image of the operation unit superimposed thereon and an auxiliary image comprising a state of the vehicle.

In the vehicle remote operation device, the operation unit may be arranged in correspondence to a position and a direction of an image of the vehicle in the composite image.

In the vehicle remote operation device, as the auxiliary image, an image comprising an image to be reflected on a mirror of the vehicle may be displayed.

In the vehicle remote operation device, as the auxiliary image, an image of an operating state of the vehicle may be displayed.

In the vehicle remote operation device, as the auxiliary image, an object approaching the vehicle may be displayed.

In the vehicle remote operation device, as the auxiliary image, a captured image obtained by capturing the lower of the vehicle may be displayed.

In the vehicle remote operation device, as the auxiliary image, information about contact between the vehicle and other object around the vehicle may be displayed.

In the vehicle remote operation device, the auxiliary image may include an image of the vehicle, the operation unit may be arranged with being superimposed on the auxiliary image, based on a position and a direction of an image of the vehicle in the auxiliary image, and the signal generation unit may be configured to generate a control signal of the vehicle, based on an operation on the operation unit in the auxiliary image.

According to an aspect of the present disclosure, there is provided a vehicle remote operation system including: the vehicle remote operation device according to one of claims 1 to 8; an image processing device configured to generate the composite image showing a surrounding area of the vehicle seen from a virtual view point, on the basis of plural captured images captured at each of the plural in-vehicle cameras mounted to the vehicle, and to transmit the composite image to the vehicle remote operation device, and a vehicle control device configured to receive a control signal of the vehicle from the vehicle remote operation device and to control the vehicle on the basis of the control signal.

According to an aspect of the present disclosure, there is provided a vehicle remote operation method including: receiving a composite image, which is to be generated on the basis of plural captured images captured at each of plural in-vehicle cameras mounted to a vehicle and shows a surrounding area of the vehicle seen from a virtual view point; displaying, on a display, the composite image and an auxiliary image comprising a state of the vehicle; superimposing an image of an operation unit for operating the vehicle on at least one of the composite image and the auxiliary image; receiving an operation of the vehicle from the operation unit; generating a control signal of the vehicle, based on the operation, and transmitting the control signal to the vehicle.

According to the configuration of the present disclosure, when performing the vehicle remote operation, the surrounding situation of the vehicle is displayed as the auxiliary image, for example, so that it is possible to perform the remote operation while checking the surrounding situation of the vehicle. That is, it is possible to improve convenience and operability of the vehicle remote operation.

### BRIEF DESCRIPTION OF DRAWINGS

Exemplary embodiments of the present invention will be described in detail based on the following figures, wherein:

FIG. 1 is a block diagram depicting a configuration of a vehicle remote operation system of an illustrative embodiment;

FIG. 2 exemplifies positions at which in-vehicle cameras are arranged at a vehicle;

FIG. 3 illustrates a method of generating a composite image showing a surrounding area of the vehicle.

FIG. 4 is a pictorial view of a portable terminal on which a composite image and an auxiliary image of Example 1 are displayed;

FIG. 5 is a pictorial view of the composite image displayed on the portable terminal in Example 1;

FIG. 6 is a flowchart depicting an example of a processing flow about a vehicle remote operation in Example 1;

FIG. 7 is a pictorial view of the portable terminal on which a composite image and an auxiliary image of Example 2 are displayed;

FIG. 8 is a pictorial view of the portable terminal on which a composite image and an auxiliary image of Example 3 are displayed;

FIG. 9 is a pictorial view of the portable terminal on which a composite image and an auxiliary image of Example 4 are displayed;

FIG. 10 is a pictorial view of the portable terminal on which a composite image and an auxiliary image of Example 5 are displayed;

FIG. 11 is a pictorial view of the portable terminal on which a composite image and an auxiliary image of Example 6 are displayed (first example);

FIG. 12 is a pictorial view of the portable terminal on which a composite image and an auxiliary image of Example 6 are displayed (second example); and

FIG. 13 is a flowchart depicting an example of a processing flow about the vehicle remote operation in Example 7.

### DETAILED DESCRIPTION

Hereinafter, an exemplary illustrative embodiment of the present disclosure will be described in detail with reference to the drawings. In the meantime, the present disclosure is not limited to the illustrative embodiment to be described later.

Also, in below descriptions, a direction that is a straight traveling direction of a vehicle and faces from a driver seat toward a steering wheel is referred to as “front direction (forward)”. A direction that is a straight traveling direction of the vehicle and faces from the steering wheel toward the driver seat is referred to as “back direction (backward)”. A direction that is perpendicular to the straight traveling direction of the vehicle and a vertical direction and leftward faces from the right of a driver facing forward is referred to as “left direction”. A direction that is perpendicular to the straight traveling direction of the vehicle and the vertical direction and faces rightward from the left of the driver facing forward is referred to as “right direction”.

### 1. Configuration of Vehicle Remote Operation System

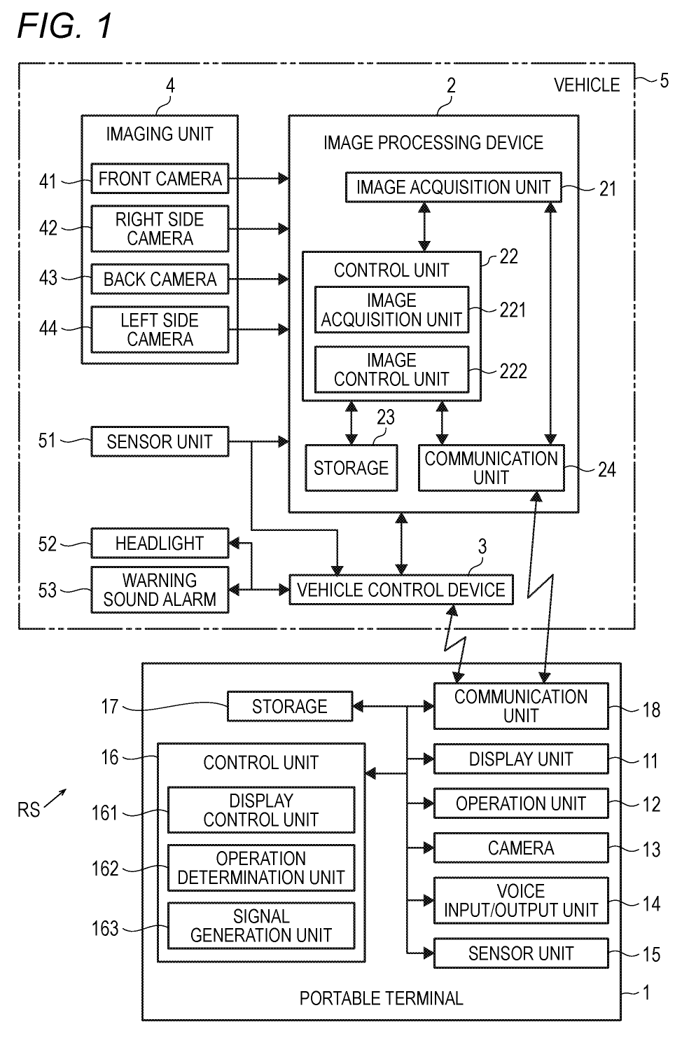

FIG. 1 is a block diagram depicting a configuration of a vehicle remote operation system RS of an illustrative embodiment. The vehicle remote operation system RS includes a portable terminal 1, an image processing device 2, and a vehicle control device 3. The portable terminal 1 is a vehicle remote operation device configured to remotely operate a vehicle 5. The image processing device 2 and the vehicle control device 3 are mounted to the vehicle 5. The vehicle remote operation system RS is a system for remotely operating the vehicle 5 by the portable terminal 1 on which a composite image showing a surrounding area of the vehicle 5 is displayed. The vehicle 5 further includes an imaging unit 4 (in-vehicle camera), a sensor unit 51, a headlight 52, and a warning sound alarm 53.

The portable terminal 1 is a device configured to receive and display an image for display, which is to be output from the image processing device 2, and to transmit a control signal to the vehicle control device 3 to remotely operate the vehicle 5. As the portable terminal 1, for example, a smart phone, a tablet-type terminal and the like that are carried by an owner of the vehicle 5 may be included. In the illustrative embodiment, the portable terminal 1 is a smart phone, for example.

The image processing device 2 is a device configured to process a captured image captured by the in-vehicle camera. The image processing device 2 is provided to each vehicle having the in-vehicle camera mounted thereto. In the illustrative embodiment, the image processing device 2 is configured to acquire and process the captured image from the imaging unit 4. Also, the image processing device 2 can acquire information from the sensor unit 51 and perform determination as to the image processing on the basis of the acquired information.

The vehicle control device 3 is configured to perform control on the entire operations of the vehicle. The vehicle control device 3 includes an engine ECU (Electronic Control Unit) configured to control an engine, a steering ECU configured to control steering, a brake ECU configured to control a brake, a shift ECU configured to control a shift, a power supply control ECU configured to control a power supply, a light ECU configured to control a light, a mirror ECU configured to control an electronic mirror, and the like. In the illustrative embodiment, the vehicle control device 3 is configured to transmit and receive information to and from the portable terminal 1 and the image processing device 2. The vehicle control device 3 is configured to receive a control signal of the vehicle 5 from the portable terminal 1, and to control the vehicle 5 on the basis of the control signal.

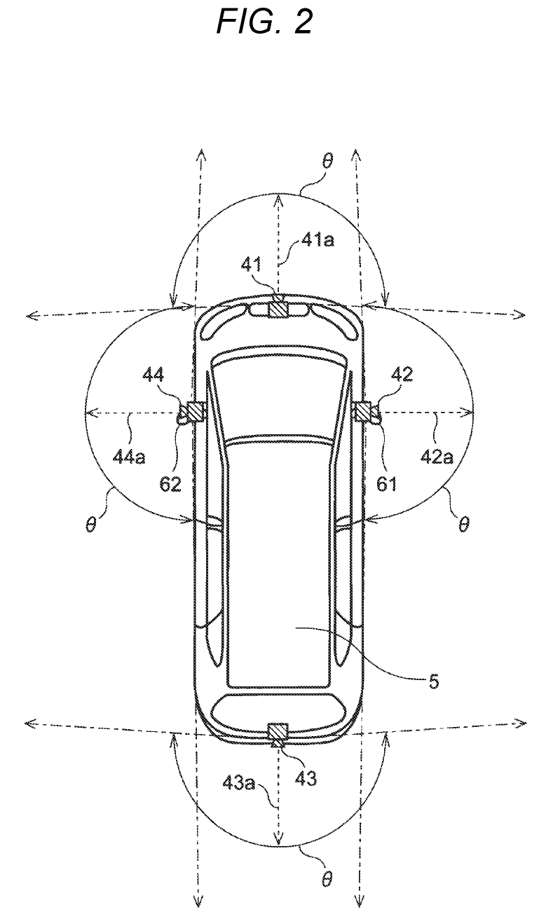

The imaging unit 4 is provided to monitor situations around the vehicle. The imaging unit 4 includes four in-vehicle cameras 41 to 44. FIG. 2 exemplifies positions at which the in-vehicle cameras 41 to 44 are arranged at the vehicle 5.

The in-vehicle camera 41 is provided at a front end of the vehicle 5. Therefore, the in-vehicle camera 41 is also referred to as ‘front camera 41’. An optical axis 41a of the front camera 41 extends in a front and back direction of the vehicle 5, as seen from above. The front camera 41 is configured to capture a front direction of the vehicle 5. The in-vehicle camera 43 is provided at a rear end of the vehicle 5. Therefore, the in-vehicle camera 43 is also referred to as ‘back camera 43’. An optical axis 43a of the back camera 43 extends in the front and back direction of the vehicle 5, as seen from above. The back camera 43 is configured to capture a back direction of the vehicle 5. The front camera 41 and the back camera 43 are preferably mounted at centers of the vehicle 5 in a right and left direction but may also be mounted at positions slightly deviating from the centers in the right and left direction.

The in-vehicle camera 42 is provided at a right door mirror 61 of the vehicle 5. Therefore, the in-vehicle camera 42 is also referred to as ‘right side camera 42’. An optical axis 42a of the right side camera 42 extends in the right and left direction of the vehicle 5, as seen from above. The right side camera 42 is configured to capture a right direction of the vehicle 5. The in-vehicle camera 44 is provided at a left door mirror 62 of the vehicle 5. Therefore, the in-vehicle camera 44 is also referred to as ‘left side camera 42’. An optical axis 44a of the left side camera 44 extends in the right and left direction of the vehicle 5, as seen from above. The left side camera 44 is configured to capture a left direction of the vehicle 5.

In the meantime, when the vehicle 5 is a so-called door mirrorless vehicle, the right side camera 42 is provided in the vicinity of a right side door rotary shaft (hinge part) without a door mirror, and the left side camera 44 is provided in the vicinity of a left side door rotary shaft (hinge part) without a door mirror.

As lenses of the in-vehicle cameras 41 to 44, a fish-eye lens is used, for example. Since each of the in-vehicle cameras 41 to 44 has a horizontal angle of view θ of 180° or greater, the in-vehicle cameras can capture an omni-directional image in the horizontal direction of the vehicle 5.

Back to FIG. 1, the sensor unit 51 includes a plurality of sensors configured to detect information about the vehicle 5 to which the in-vehicle cameras 41 to 44 are mounted. The information about the vehicle 5 may include information about the vehicle itself, and information around the vehicle. In the illustrative embodiment, the sensor unit 51 includes a vehicle speed sensor configured to detect a speed, a steering angle sensor configured to detect a rotating angle of a steering, an accelerator opening degree sensor configured to detect an opening degree of an accelerator, a shift sensor configured to detect an operation position of a shift lever of a transmission of the vehicle, an illuminance sensor configured to detect an illuminance around the vehicle, a vibration sensor configured to detect vibrations of the vehicle, an inclination sensor configured to detect an inclination of the vehicle, an obstacle sensor configured to detect a person, an animal, a vehicle and other object around the vehicle, and the like, for example.

The obstacle sensor can detect a person, an animal, a vehicle and other object around the vehicle by using an ultrasonic sensor, an optical sensor using infrared or the like, a radar, and the like. The obstacle sensor is embedded at a plurality of places such as a front bumper, a rear bumper, a door and the like of the vehicle 5, for example. The obstacle sensor is configured to detect whether a person, other vehicle and the like exist and directions and positions thereof by transmitting transmission waves around the vehicle and receiving reflected waves reflected at the person, the other vehicle and the like.

The headlight 52 is provided at a front end of the vehicle 5. The headlight 52 is an illumination device configured to illuminate the front of the vehicle 5. The warning sound alarm 53 is a so-called horn, and is configured to generate a warning sound around the vehicle.

### 2. Configuration of Portable Terminal

The portable terminal 1 includes a display (display unit)11, an operation unit 12, cameras 13, a voice input/output unit 14, a sensor unit 15, a control unit 16, a storage 17 and a communication unit 18.

The display 11 is arranged at a front face of the portable terminal 1, which is a smart phone. The display 11 is configured to display thereon an image for display output from the image processing device 2, for example. The display 11 is a liquid crystal panel, for example, and includes a touch panel, which is a part of the operation unit 12, on a surface thereof.

The operation unit 12 includes the touch panel provided on the surface of the display 11, other operation buttons and the like, for example. The operation unit 12 is configured so that a user can input information from an outside, such as inputs of characters, numerical values and the like, selection of a menu and other options, execution and cancel of processing, and the like. In the illustrative embodiment, the operation unit 12 is a touch panel that is used to operate the vehicle 5.

The cameras 13 are arranged at a front face and a backside of the portable terminal 1, which is a smart phone. The front camera 13 is configured to capture a peripheral image at the front of the portable terminal 1. The rear camera 13 is configured to capture a peripheral image at the rear of the portable terminal 1.

The voice input/output unit 14 includes a microphone and a speaker, for example. The microphone is configured to acquire voice information around the portable terminal 1, including voice to be uttered by the user. The speaker is configured to generate a warning sound, a voice on a communication line, and the like toward the outside.

The sensor unit 15 includes sensors configured to detect information about the portable terminal 1. In the illustrative embodiment, the sensor unit 15 includes a vibration sensor configured to detect vibrations of the portable terminal, an inclination sensor configured to detect an inclination of the portable terminal, a GPS (Global Positioning System) sensor configured to detect position information of the portable terminal, and the like. The vibration sensor may also be configured to detect a shock to the portable terminal from the outside. An acceleration sensor and a gyro sensor may be configured to also serve as the vibration sensor and the inclination sensor, and to detect vibrations, shock and inclination of the portable terminal, respectively. Also, the sensor unit 15 includes a vibration motor for vibrating the portable terminal 1.

The control unit 16 is a so-called microcomputer including a CPU (Central Processing Unit), a RAM (Random Access Memory) and a ROM (Read Only Memory), which are not shown. The control unit 16 is configured to process, transmit and receive the information on the basis of programs stored in the storage 17. The control unit 16 is connected to the display 11, the operation unit 12, the camera 13, the voice input/output unit 14, the sensor unit 15, the storage 17 and the communication unit 18 in a wired manner.

The control unit 16 includes a display control unit 161, an operation determination unit 162, and a signal generation unit 163. The functions of the respective constitutional elements of the control unit 16 are implemented as the CPU executes calculation processing in accordance with programs.

The display control unit 161 is configured to control display contents of the display 11. For example, when receiving inputs about executions and settings of diverse functions of the portable terminal 1, the display control unit 161 displays functional images relating to the functions on the display 11. The functional images are images corresponding to the diverse functions of the portable terminal 1, and include an icon, a button, a soft key, a slide bar, a slide switch, a check box, a text box and the like. The user can execute and set the diverse functions of the portable terminal 1 by touching and selecting the functional images displayed on the display 11 via the touch panel (operation unit 12).

The operation determination unit 162 is configured to receive a detection signal output from the touch panel (operation unit 12) and to determine an operation content on the touch panel on the basis of the detection signal. The operation determination unit 162 is configured to determine tap, drag, flick and the like operations, in addition to position information on the touch panel. When the operation is an operation accompanied by movement such as drag and flick, a moving direction, a moving amount and the like thereof are also determined. The signal generation unit 163 is configured to generate a control signal of the vehicle 5 based on an operation on the operation unit 12. The generated control signal of the vehicle 5 is transmitted to the vehicle control device 3 via the communication unit 18.

The storage 17 is a non-volatile memory such as a flash memory, and a variety of information is stored therein. In the storage 17, a program as firmware, a variety of data necessary for the control unit 16 to execute the diverse functions, and the like are stored.

The communication unit 18 is wirelessly connected to diverse external devices, for example. The portable terminal 1 can receive an image for display (composite image), which is generated by the image processing device 2 of the vehicle 5 and shows a surrounding area of the vehicle 5, and a variety of information (information of steering angle, accelerator opening degree, shift position, vehicle speed, obstacle and the like) detected by the sensor unit 51 via the communication unit 18. The portable terminal 1 can transmit the control signal of the vehicle 5 based on the operation on the operation unit 12 to the vehicle control device 3 via the communication unit 18.

### 3. Configuration of Image Processing Device

The image processing device 2 includes an image generation unit 21, a control unit 22, a storage 23 and a communication unit 24.

The image generation unit 21 is configured to process a captured image captured by the imaging unit 4 and to generate an image for display. In the illustrative embodiment, the image generation unit 21 is configured by a hardware circuit capable of executing a variety of image processing. In the illustrative embodiment, the image generation unit 21 is configured to generate a composite image showing a surrounding of the vehicle 5, as seen from a virtual view point, based on the captured images captured by the in-vehicle cameras 41 to 44 mounted to the vehicle 5. Also, the image generation unit 21 is configured to generate the image for display to be displayed on the portable terminal 1, based on the composite image. A method of generating the composite image will be described later in detail.

The control unit 22 is a so-called microcomputer including a CPU, a RAM and a ROM, which are not shown. The control unit 22 is configured to process, transmit and receive the information on the basis of programs stored in the storage 23. The control unit 22 is connected to the portable terminal 1, the vehicle control device 3, the imaging unit 4 and the sensor unit 51 in a wired or wireless manner.

The control unit 22 includes an image acquisition unit 221 and an image control unit 222. The functions of the respective constitutional elements of the control unit 22 are implemented as the CPU executes calculation processing in accordance with programs.

The image acquisition unit 221 is configured to acquire the captured images captured at the in-vehicle cameras 41 to 44. In the illustrative embodiment, the number of the in-vehicle cameras 41 to 44 is four, and the image acquisition unit 221 is configured to acquire the captured images captured at the respective in-vehicle cameras 41 to 44.

The image control unit 222 is configured to control image processing that is to be executed by the image generation unit 21. For example, the image control unit 222 is configured to issue instructions of diverse parameters and the like, which are necessary to generate the composite image and the image for display, to the image generation unit 21. Also, the image control unit 222 is configured to control output of the image for display, which is generated by the image generation unit 21, to the portable terminal 1. In the meantime, in the descriptions, “the image for display of the composite image” to be displayed on the display 11 of the portable terminal 1 may be simply referred to as “composite image”.

The storage 23 is a non-volatile memory such as a flash memory, and a variety of information is stored therein. In the storage 23, a program as firmware, a variety of data necessary for the image generation unit 21 to generate the composite image and the image for display are stored. Also, in the storage 23, diverse data necessary for the image acquisition unit 221 and the image control unit 222 to execute processing are stored.

The communication unit 24 is wirelessly connected to the portable terminal 1, for example. The image processing device 2 can output the image for display generated at the image generation unit 21 and a variety of information (information of steering angle, accelerator opening degree, shift position, vehicle speed, obstacle and the like) detected by the sensor unit 51 to the portable terminal 1 via the communication unit 24.

### 4. Generation of Composite Image

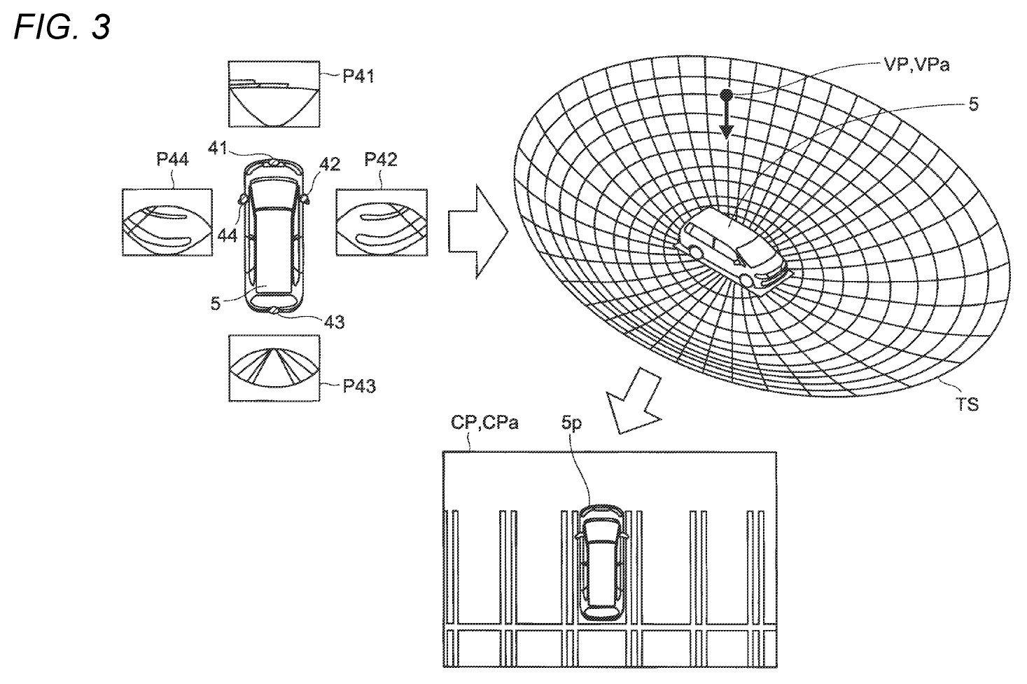

A method with which the image generation unit 21 generates a composite image showing a surrounding image of the vehicle 5, as seen from a virtual view point, is described. FIG. 3 illustrates a method of generating a composite image CP showing a surrounding area of the vehicle 5.

By the front camera 41, the right side camera 42, the back camera 43 and the left side camera 44, four captured images P41 to P44 showing the front, right side, rear and left side of the vehicle 5 are acquired at the same time. The four captured images P41 to P44 include data of entire surroundings of the vehicle 5. The image generation unit 21 acquires the four captured images P41 to P44 via the image acquisition unit 221.

The image generation unit 21 projects data (values of respective pixels) included in the four captured images P41 to P44 to a projection plane TS, which is a stereoscopic curved surface of a virtual three-dimensional space. The projection plane TS has a substantially semi-spherical shape (bowl shape), for example, and a central part thereof (a bottom part of the bowl) is determined as a position of the vehicle 5.

On the projection plane TS, the data of the captured images is projected to an area outside an area of the vehicle 5. A correspondence relation between a position of each pixel included in the captured images P41 to P44 and a position of each pixel of the projection plane TS is determined in advance. Table data indicating the correspondence relation is stored in the storage 23. The value of each pixel of the projection plane TS can be determined on the basis of the correspondence relation and the value of each pixel included in the captured images P41 to P44.

Then, the image generation unit 21 sets a virtual view point VP for the three-dimensional space under control of the image control unit 222. The virtual view point VP is defined by a view point position and a view point direction. The image generation unit 21 can set the virtual view point VP at any view point position in any view point direction for the three-dimensional space. The image generation unit 21 cuts, as an image, data projected to an area, which is included in a viewing field seen from the set virtual view point VP, of the projection plane TS. Thereby, the image generation unit 21 generates a composite image seen from any virtual view point VP.

For example, as shown in FIG. 3, when a virtual view point VPa of which a view point position is set immediately above the vehicle 5 and a line of sight is set to face immediately downward is set, it is possible to generate a composite image (aerial image) CPa looking down the vehicle 5 and the surroundings of the vehicle 5.

In the meantime, an image 5p of the vehicle 5 shown in the composite image CPa is prepared in advance as data of bitmap or the like, and is stored in the storage 23. When generating the composite image, the data of the image 5p of the vehicle 5 having a shape corresponding to the view point position and line of sight of the virtual view point VP of the composite image is read out and included in the composite image CPa.

In this way, the image generation unit 21 can generate the composite image CPa having realistic sensation close to the reality by using the virtual stereoscopic projection plane TS.

Also, it is possible to check the surrounding area of the vehicle 5 by using a composite image, which shows the surrounding area of the vehicle 5 and is generated on the basis of a plurality of captured images captured by the plurality of in-vehicle cameras 41 to 44 mounted to the vehicle 5, not the cameras 13 of the portable terminal 1. Thereby, it is possible to check an area, which is a dead zone area from a position of the user, for example, an opposite area of the vehicle 5 shielded by the vehicle 5, as seen from the position of the user.

### 5. Outline of Vehicle Remote Operation by Portable Terminal

### 5-1. Example 1

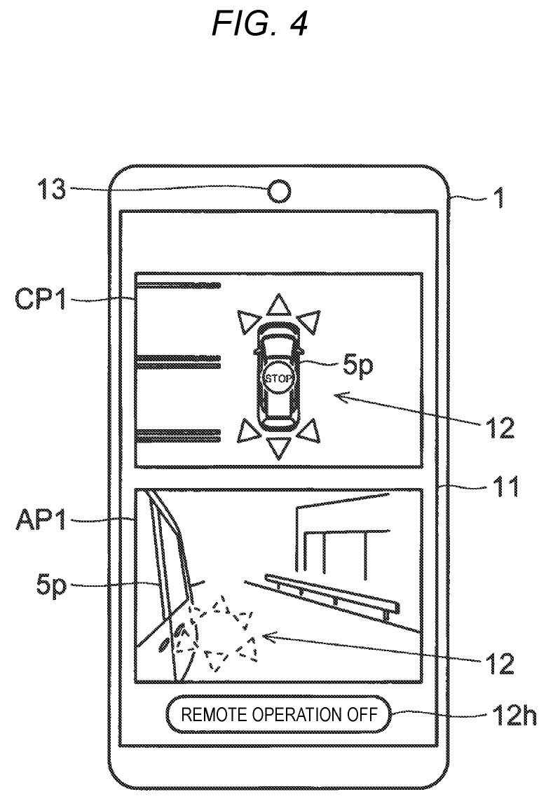

The portable terminal 1 can receive the image for display (composite image) that is to be output from the image processing device 2, and display the same on the display 11. FIG. 4 is a pictorial view of the portable terminal 1 on which a composite image CP1 and an auxiliary image AP1 of Example 1 are displayed. The display 11 of the portable terminal 1 displays the composite image CP1 and the auxiliary image AP1. The display 11 displays the composite image CP1 at an upper side, and the auxiliary image AP1 at a lower side, for example. However, the arrangement in the upper and lower direction may be reversed.

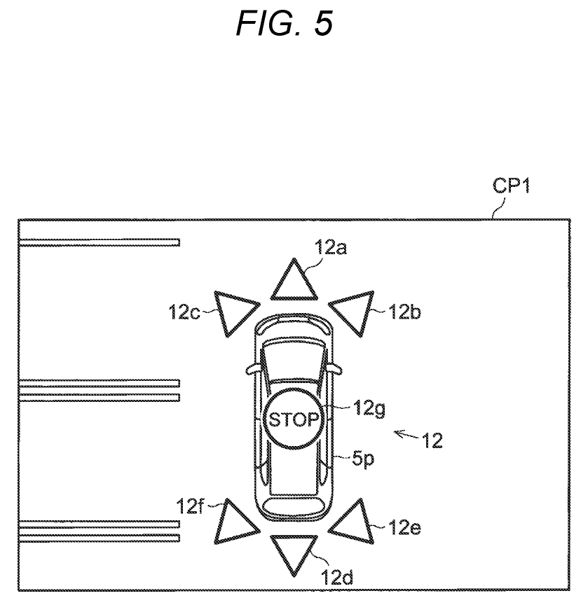

FIG. 5 is a pictorial view of the composite image CP1 displayed on the portable terminal 1 in Example 1. As shown in FIG. 5, the portable terminal 1 displays icons and the like, which are functional images relating to operations of the vehicle 5, on the display 11 when remotely operating the vehicle 5. That is, the icons and the like, which are an image of the operation unit 12, are superimposed on the composite image CP1. The operation unit 12 is arranged in correspondence to a position and a direction of the image 5p of the vehicle 5 in the composite image CP1.

Specifically, on the screen of the display 11, an icon 12a relating to forward movement, an icon 12b relating to an obliquely forward right direction, an icon 12c relating to an obliquely forward left direction, an icon 12d relating to backward movement, an icon 12e relating to an obliquely backward right direction and an icon 12f relating to an obliquely backward left direction are displayed with being superimposed on the composite image CP1, for example. The icons relating to the traveling of the vehicle 5 are arranged at positions corresponding to respective traveling directions around the image 5p of the vehicle 5, for example. In the meantime, in Example 1, the icon indicating the traveling direction of the vehicle 5 is formed to have a triangular shape, for example. However, other shapes such as an arrow shape can also be used.

Also, an icon 12g shown with “STOP” relating to stop of the vehicle 5 is arranged with being superimposed on the image 5p of the vehicle 5. Also, an icon 12h for ending the remote operation of the vehicle 5 is displayed outside the composite image CP1.

The user can arbitrarily operate the icons with a fingertip. The operation determination unit 162 determines an operation content corresponding to the icon, based on the detection signal of the touch panel (operation unit 12). The signal generation unit 163 generates a control signal of the vehicle 5, based on the operation content corresponding to the icon. The control signal is transmitted to the vehicle control device 3 via the communication unit 18.

For example, when the user pushes (taps) the icon 12a relating to forward movement of the vehicle 5 one time, the vehicle 5 is moved forward by a predetermined distance (for example, 10 cm). Also, for example, when the user pushes the icon 12c relating to an obliquely forward left direction of the vehicle 5 one time, the vehicle 5 changes a steering angle by a predetermined angle so as to move in an obliquely forward left direction. At this time, whenever changing the steering angle, the direction of the image 5p of the vehicle 5 may be changed so as to easily perceive a direction in which the vehicle is turned and moved. Continuously, when the user pushes the icon 12a relating to forward movement one time, the vehicle 5 is moved move in an obliquely forward left direction by a predetermined distance. In the meantime, the traveling direction, traveling distance and the like of the vehicle 5 may be controlled on the basis of an operation accompanied by movement, such as drag, flick and the like on the touch panel (operation unit 12).

When the user pushes the icon 12g on which “STOP” is shown so as to stop the traveling vehicle 5 on the way, the vehicle 5 is stopped. In the meantime, a configuration where the vehicle 5 is enabled to travel only for a time period in which the user pushes the icon 12a relating to forward movement or the icon 12d relating to backward movement and the vehicle 5 is stopped when the user detaches the finger from the icons is also possible.

During the remote operation, an obstacle such as a person, an animal, a vehicle and other objects around the vehicle is detected by the sensor unit 51. When the sensor unit 51 detects the obstacle, the detection signal is transmitted to the vehicle control device 3, so that the vehicle control device 3 automatically stops the vehicle 5.

Back to FIG. 4, the auxiliary image AP1 includes other object around the vehicle 5, a distance from the vehicle 5 to an obstacle or a parking frame, and a state of the vehicle 5 such as an operating state of the vehicle 5, for example. In Example 1, the display 11 displays, as the auxiliary image AP1, an image including an image reflected on the right door mirror 61, for example. In the meantime, the auxiliary image AP1 may be a fender mirror image or a room mirror image including an image at the rear of the vehicle 4, for example. Thereby, the auxiliary image AP1 includes the image 5p of the vehicle 5.

Also, the icons and the like, which are an image of the operation unit 12, may be superimposed on the auxiliary image AP1, too. In this case, the icons and the like, which are an image of the operation unit 12, are arranged with being superimposed on the auxiliary image AP1, based on a position and a direction of the image 5p of the vehicle 5 in the auxiliary image AP1. More specifically, since the auxiliary image AP1 is a standard with respect to an operating direction of the vehicle 5, an operating direction indicated by the icon is preferably determined on the basis of the position and direction of the image 5p of the vehicle 5 included in the auxiliary image AP1. Thereby, it is possible to perform the remote operation of the vehicle 5 based on the auxiliary image AP1, i.e., the remote operation of the vehicle 5 with checking the auxiliary image AP1.

In the meantime, regarding the operation using the icon of the operation unit 12 superimposed on the auxiliary image AP1, it is necessary to generate each control data of the vehicle 5 so that the vehicle 5 is to move in a direction corresponding to the operating direction. The control data corresponding to each icon operation is stored in advance in a table, for example. When the icon operation is performed on the auxiliary image AP1, the signal generation unit 163 reads out the control data corresponding to the icon operation from the table, and generates a control signal of the vehicle 5, based on the operation on the icon of the operation unit 12 in the auxiliary image AP1. The generated control signal of the vehicle 5 is transmitted to the vehicle control device 3 via the communication unit 18, and is used to control the vehicle 5.

In correspondence to a case where types of the auxiliary image are different, preferably, a table is stored for each type of the auxiliary image, and conversion processing data (equation) is stored for each type of the auxiliary image. Thereby, even when the types of the auxiliary image are different, it is possible to remotely operate the vehicle 5 in the auxiliary image.

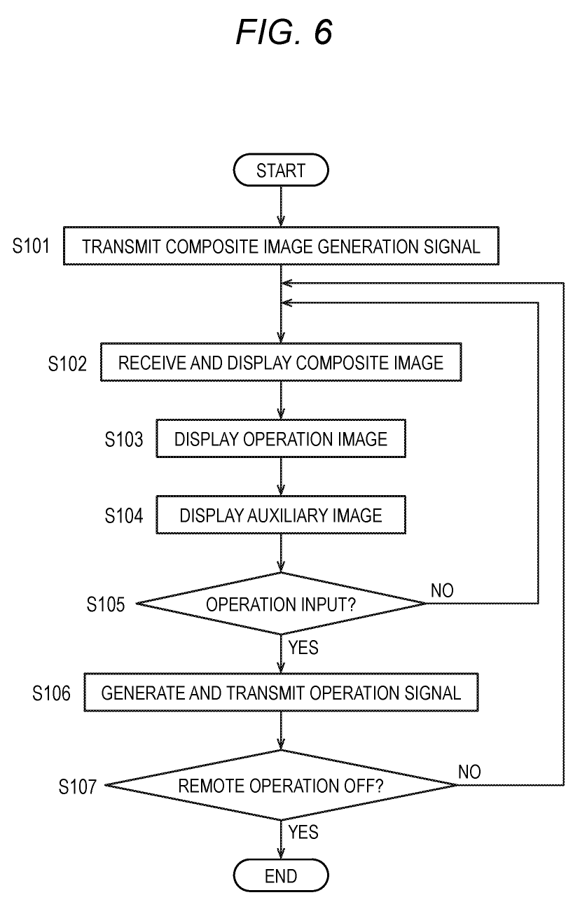

FIG. 6 is a flowchart depicting an example of a processing flow about the vehicle remote operation in Example 1. The processing about the remote operation of the vehicle 5, which is to be executed by the portable terminal 1 in Example 1, is described with reference to the processing flow of FIG. 6.

The portable terminal 1 is operated by the user, for example, and starts the processing about the remote operation of the vehicle 5 when an instruction to start the remote operation is received from the operation unit 12 (“START” in FIG. 6). The remote operation of the vehicle 5 starts in a state where the vehicle 5 is stopped.

Then, the portable terminal 1 transmits a control signal relating to generation of the composite image CP1 to the image processing device 2 of the vehicle 5 (step S101). The image processing device 2 acquires a plurality of images around the vehicle 5 from each of the in-vehicle cameras 41 to 44. In the image generation unit 21, the composite image CP1 showing the surrounding area of the vehicle 5 seen from the virtual view point is generated on the basis of the plurality of images around the vehicle 5.

Then, the portable terminal 1 receives the composite image CP1 from the image processing device 2, and displays the composite image CP1 on the display 11 (step S102). Continuously, the portable terminal 1 displays the icons and the like (operation unit 12), which are functional images about the operation of the vehicle 5, on the display 11 with superimposing the same on the composite image CP1 (step S103). Thereby, the user can arbitrarily operate the icons for remote operation with the finger.

Then, the portable terminal 1 displays the auxiliary image AP1 on the display 11 (step S104). The auxiliary image AP1 includes a state of the vehicle 5, and is a side mirror image in Example 1, for example.

Then, the portable terminal 1 determines whether the user has performed an operation input on the operation unit 12 (step S105). When there is no operation input on the operation unit 12 (No in step S105), the portable terminal 1 returns to step S102 and continues to receive and display the composite image CP1.

When there is an operation input on the operation unit 12 (Yes in step S105), the portable terminal 1 generates a control signal of the vehicle 5 on the basis of the operation on the operation unit 12 by using the signal generation unit 163, and transmits the control signal to the vehicle control device 3 (step S106). Thereby, the user can perform the remote operation of the vehicle 5.

Then, the portable terminal 1 determines whether the user has performed an OFF operation of the remote operation of the vehicle 5 (step S107). The user can end the remote operation of the vehicle by operating the icon 12h for ending the remote operation of the vehicle 5. When there is no OFF operation of the remote operation (No in step S107), the portable terminal 1 returns to step S102 and continues to receive and display the composite image CP1.

When an OFF operation of the remote operation has been performed (Yes in step S107), the processing flow shown in FIG. 6 is over.

As described above, the portable terminal 1, which is the vehicle remote operation device of Example 1, displays the composite image CP1, on which the image of the operation unit 12 is superimposed, and the auxiliary image AP1, which includes a state of the vehicle 5, on the display 11. According to this configuration, when performing the remote operation of the vehicle 5, it is possible to display the surrounding situation of the vehicle 5, as the auxiliary image AP1, for example. Therefore, it is possible to perform the remote operation while checking the surrounding situation of the vehicle 5. That is, it is possible to improve convenience and operability of the remote operation of the vehicle 5.

Also, on the display 11, the operation unit 12 is arranged in correspondence to the position and direction of the image 5p of the vehicle 5 in the composite image CP1. According to this configuration, it is possible to easily perceive the operating direction of the vehicle 5. Therefore, it is possible to improve the operability of the remote operation of the vehicle 5.

Also, the display 11 displays an image, which includes an image reflected on the mirror of the vehicle 5, as the auxiliary image AP1. According to this configuration, it is possible to check the surrounding situation of the vehicle 5 reflected on the mirror of the vehicle 5, on the display 11 of the portable terminal 1. That is, it is possible to perform the remote operation as if the user drives the vehicle 5 on a driver seat, so that it is possible to further improve the convenience and operability of the remote operation of the vehicle 5.

### 5-2. Example 2

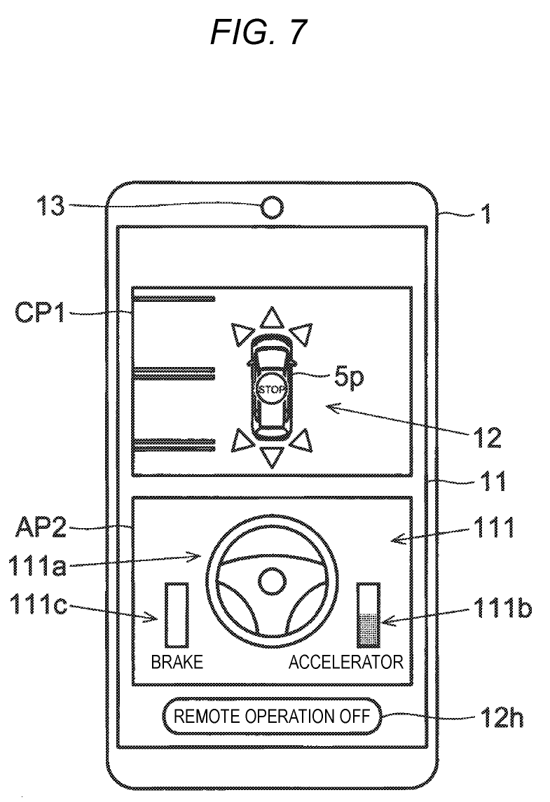

FIG. 7 is a pictorial view of the portable terminal 1 on which the composite image CP1 and an auxiliary image AP2 of Example 2 are displayed. In Example 2, the portable terminal 1 displays, on the screen of the display 11, a plurality of icons relating to the remote operation of the vehicle 5, as the operation unit 12, with superimposing the same on the composite image CP1.

Also, the display 11 of the portable terminal 1 displays the auxiliary image AP2 below the composite image CP1. In the meantime, the arrangement of the composite image CP1 and the auxiliary image AP2 in the upper and lower direction may be reversed. The display 11 displays an image 111, which shows an operating state of the vehicle 5 itself, as the auxiliary image AP2. The image 111, which shows an operating state of the vehicle 5 itself, includes a steering wheel image 111a, an accelerator image 111b, and a brake image 111c, for example.

The steering wheel image 111a is an image showing a rotating angle of a steering wheel of the actual vehicle 5. The steering wheel image 111a rotates about a central axis, in conjunction with rotation of the steering wheel of the vehicle 5 operated by the operation unit 12. The accelerator image 111b is an image showing a degree of accelerator pedal depression of the actual vehicle 5. The accelerator image 111b expresses the degree of accelerator pedal depression by an indicator, for example. The brake image 111c is an image showing a degree of brake pedal depression of the actual vehicle 5. The brake image 111c expresses the degree of brake pedal depression by an indicator, for example.

In the meantime, the images can be generated from the variety of information (the information of steering angle, accelerator opening degree, shift position, vehicle speed, obstacle and the like) detected at the sensor unit 51 of the vehicle 5 and received via the communication unit 18.

According to the configuration of the portable terminal 1 of Example 2, it is possible to check an operating state of the actual vehicle 5 itself, such as a steering wheel, on the display 11 of the portable terminal 1. For example, it is possible to easily check to what extent the steering wheel is rotated and which direction a tire is facing, without approaching the vehicle 5. Therefore, it is possible to further improve the convenience and operability of the remote operation of the vehicle 5.

### 5-3. Example 3

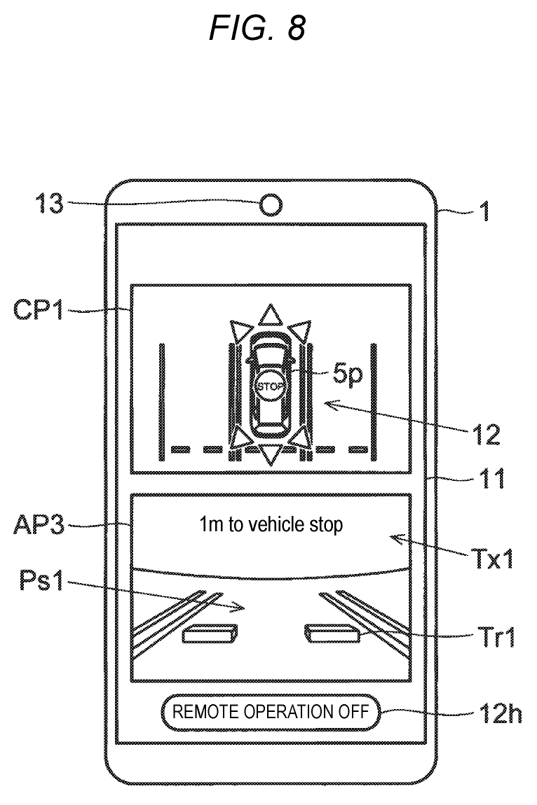

FIG. 8 is a pictorial view of the portable terminal 1 on which the composite image CP1 and an auxiliary image AP3 of Example 3 are displayed. In Example 3, the portable terminal 1 displays, on the screen of the display 11, a plurality of icons relating to the remote operation of the vehicle 5, as the operation unit 12, with superimposing the same on the composite image CP1.

Also, the display 11 of the portable terminal 1 displays the auxiliary image AP3 below the composite image CP1. In the meantime, the arrangement of the composite image CP1 and the auxiliary image AP3 in the upper and lower direction may be reversed. The display 11 displays an object, which is approaching the vehicle 5, as the auxiliary image AP3. For example, when parking the vehicle 5 in a parking space Ps1 by the remote operation, a vehicle stop Tr1 approaching the vehicle 5 is displayed with being enlarged in the auxiliary image AP3. Also, a text Tx1, which indicates a distance of the vehicle 5 to the vehicle stop Tr1, is displayed in the auxiliary image AP3.

In the meantime, an object approaching the vehicle 5 is detected by the sensor unit 51 of the vehicle 5. The object approaching the vehicle 5 includes a sidewall, a person, an animal, a vehicle, other object and the like around the vehicle 5, for example, in addition to the vehicle stop Tr1.

According to the configuration of the portable terminal 1 of Example 3, it is possible to easily check a state of the vehicle 5 relating to the object approaching the vehicle 5. Therefore, it is possible to increase the safety upon the remote operation and to further improve the convenience of the remote operation of the vehicle 5.

### 5-4. Example 4

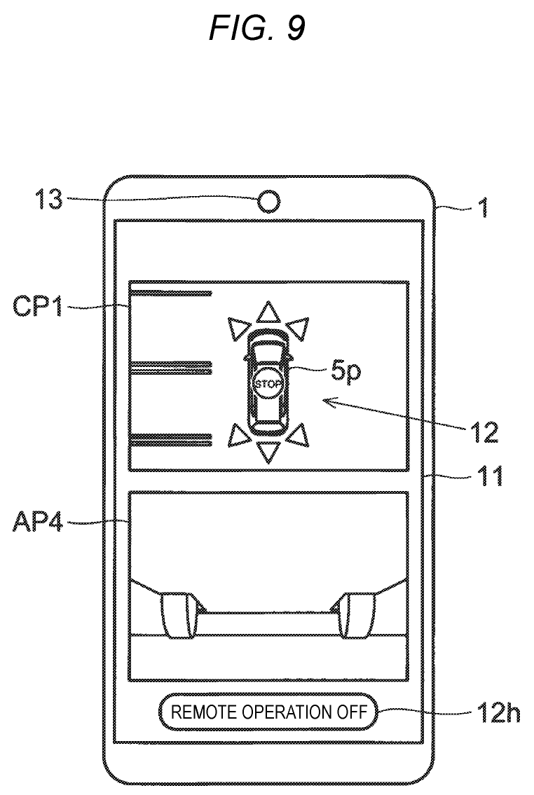

FIG. 9 is a pictorial view of the portable terminal 1 on which the composite image CP1 and an auxiliary image AP4 of Example 4 are displayed. In Example 4, the portable terminal 1 displays, on the screen of the display 11, a plurality of icons relating to the remote operation of the vehicle 5, as the operation unit 12, with superimposing the same on the composite image CP1.

Also, the display 11 of the portable terminal 1 displays the auxiliary image AP4 below the composite image CP1. In the meantime, the arrangement of the composite image CP1 and the auxiliary image AP4 in the upper and lower direction may be reversed. The display 11 displays a captured image obtained by capturing the lower of the vehicle 5, as the auxiliary image AP4. The lower area of the vehicle 5 may be an image captured between a bottom of the vehicle 5 and a ground surface. Regarding this, the vehicle 5 further includes an in-vehicle camera configured to capture the lower of the vehicle 5, in addition to the in-vehicle cameras 41 to 44.

According to the configuration of the portable terminal 1 of Example 4, it is possible to check a situation below the vehicle 5 on the display 11 of the portable terminal 1. That is, it is possible to easily check the situation below the vehicle 5, which cannot be checked during usual driving, without approaching the vehicle 5. Accordingly, it is possible to further improve the convenience and operability of the remote operation of the vehicle 5.

### 5-5. Example 5

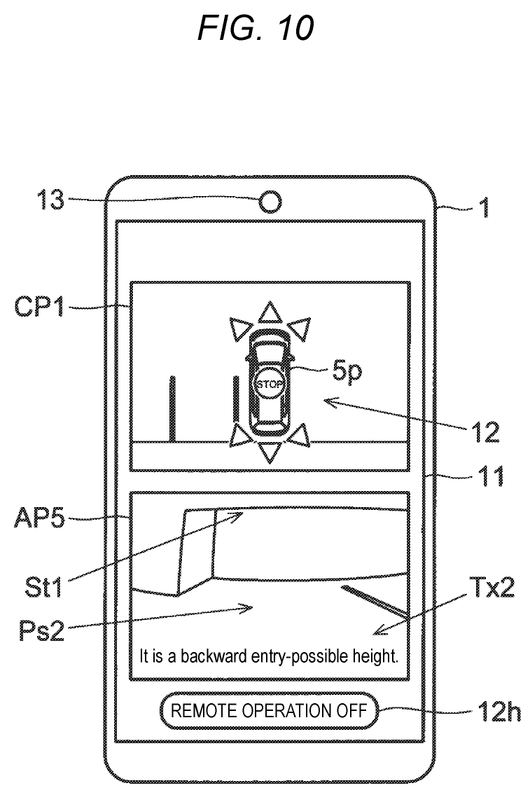

FIG. 10 is a pictorial view of the portable terminal 1 on which the composite image CP1 and an auxiliary image AP5 of Example 5 are displayed. In Example 5, the portable terminal 1 displays, on the screen of the display 11, a plurality of icons relating to the remote operation of the vehicle 5, as the operation unit 12, with superimposing the same on the composite image CP1.

Also, the display 11 of the portable terminal 1 displays the auxiliary image AP5 below the composite image CP1. In the meantime, the arrangement of the composite image CP1 and the auxiliary image AP5 in the upper and lower direction may be reversed. The display 11 displays an image at the rear of the vehicle 5 when parking the vehicle 5 in a parking space Ps2 by the remote operation, for example, as the auxiliary image AP5.

In the exemplified parking space Ps2, a structure St1 exists above the parking space of the vehicle, for example. In the auxiliary image AP5, an image of the structure St1 is included. Here, the portable terminal 1 calculates a height from a bottom to the structure St1, based on the auxiliary image AP5. Then, the portable terminal 1 compares a vehicle height of the vehicle 5 and the height of the structure St1, and determines whether the vehicle 5 can enter below the structure St1. In the meantime, information about a size of the vehicle 5 itself is stored in advance in the storage 17 and the like. Also, in the auxiliary image AP5, a text Tx2, which indicates whether the vehicle 5 can enter below the structure St1, is shown.

As described above, the display 11 of the portable terminal 1 of Example 4 displays information about contact between the vehicle 5 and the other object around the vehicle 5, as the auxiliary image. According to this configuration, it is possible to check the information about contact between the vehicle 5 and the other object around the vehicle 5 on the display 11 of the portable terminal 1. Specifically, for example, when the structure St1 exists above the parking space of the vehicle, it is possible to check whether the vehicle 5 is to contact the structure St1, on the display 11 of the portable terminal 1. Accordingly, it is possible to further improve the convenience and operability of the remote operation of the vehicle 5.

### 5-6. Example 6

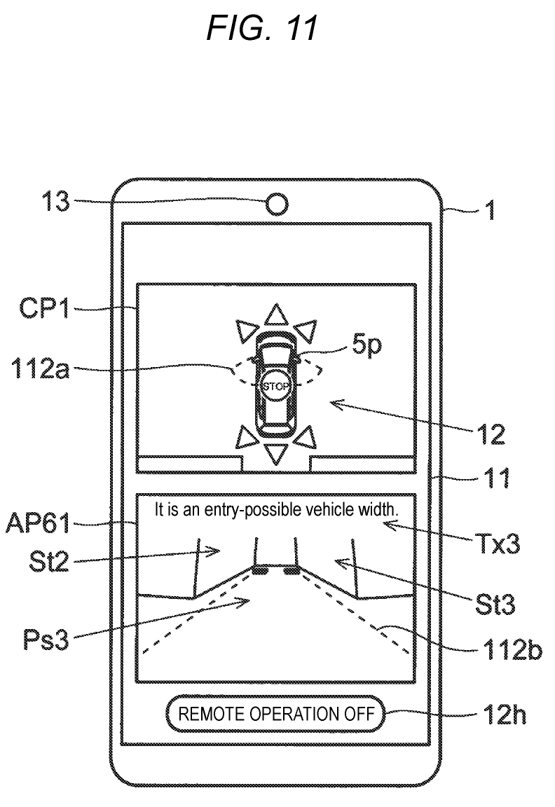

FIG. 11 is a pictorial view of the portable terminal 1 on which the composite image CP1 and an auxiliary image AP61 of Example 6 are displayed (first example). In Example 6, the portable terminal 1 displays, on the screen of the display 11, a plurality of icons relating to the remote operation of the vehicle 5, as the operation unit 12, with superimposing the same on the composite image CP1.

Also, the display 11 of the portable terminal 1 displays the auxiliary image AP61 below the composite image CP1. In the meantime, the arrangement of the composite image CP1 and the auxiliary image AP61 in the upper and lower direction may be reversed. The display 11 displays an image at the rear of the vehicle 5 when parking the vehicle 5 in a parking space Ps3 by the remote operation, for example, as the auxiliary image AP61.

In the exemplified parking space Ps3, wall parts St2, St3 exist at the left and right sides of the parking space of the vehicle, for example. In the auxiliary image AP61, images of the wall parts St2, St3 are included. Here, the portable terminal 1 calculates an interval of the wall parts St2, St3 in a vehicle width direction, based on the auxiliary image AP61. Then, the portable terminal 1 compares a vehicle width of the vehicle 5 and the interval of the wall parts St2, St3, and determines whether the vehicle 5 can enter the parking space Ps3. In the meantime, the information about the size of the vehicle 5 itself is stored in advance in the storage 17 and the like. Also, in the auxiliary image AP61, a text Tx3, which indicates whether the vehicle 5 can enter the parking space Ps3, is shown.

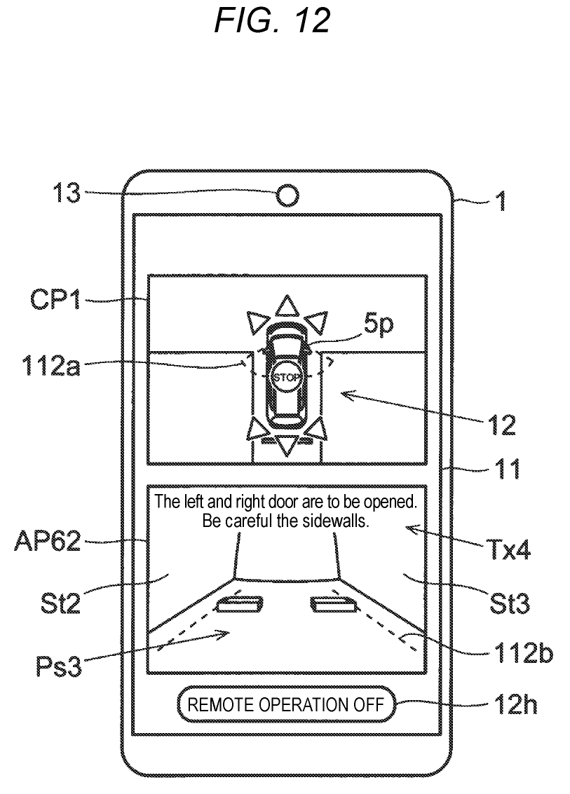

Continuously, when the vehicle 5 enters the parking space Ps3, the display 11 of the portable terminal 1 displays an auxiliary image AP62 below the composite image CP1. FIG. 12 is a pictorial view of the portable terminal 1 on which the composite image CP1 and an auxiliary image AP62 of Example 6 are displayed (second example). The composite image CP1 and the auxiliary image AP62 show a state where a part of the vehicle 5 has entered the parking space Ps3, for example. Here, the portable terminal 1 compares a vehicle width of the vehicle 5 in a state where the left and right doors are opened, and the interval of the wall parts St2, St3, and determines whether it is possible to sufficiently open the left and right doors of the vehicle 5 having parked in the parking space Ps3. Also, in the auxiliary image AP62, a text Tx4, which indicates whether it is possible to sufficiently open the left and right doors of the vehicle 5 in the parking space Ps3, is displayed.

As described above, the display 11 of the portable terminal 1 of Example 6 displays the information about the contact between the vehicle 5 and the other object around the vehicle 5, as the auxiliary image. According to this configuration, it is possible to check the information about the contact between the vehicle 5 and the other object around the vehicle 5 on the display 11 of the portable terminal 1. Specifically, for example, when the wall parts St2, St3 exist at the left and right sides in the parking space of the vehicle, it is possible to check whether the vehicle 5 is to contact the wall parts St2, St3, on the display 11 of the portable terminal 1. Also, it is possible to check whether it is possible to sufficiently open the left and right doors of the vehicle 5 in the parking space. Accordingly, it is possible to further improve the convenience and operability of the remote operation of the vehicle 5.

In the meantime, regarding the contact between the vehicle and the other object around the vehicle, the other object is not limited to the side wall. The other object includes a person, an animal, a vehicle and another object, for example. Also, regarding the contact between the vehicle and the other object around the vehicle, it is possible to check the front and rear of the vehicle as well as the left and right sides of the vehicle. Also, for example, the information as to whether it is possible to sufficiently open the door of the vehicle may be displayed before the vehicle enters the parking space or the like.

In the meantime, as shown in FIGS. 11 and 12, in the composite image CP1 and the auxiliary image AP62, a door opening range line 112a, a vehicle width line 112b and the like may be displayed. The door opening range line 112a indicates a movement range of a door when opening the door. The vehicle width line 112b is a line along which a left or right end of the vehicle extends in the front and rear direction of the vehicle or a line along which a left or right end of the vehicle extends in a vehicle traveling direction estimated from a steering angle and the like. Thereby, it is possible to easily check rooms of the vehicle 5 in the left and right direction.

### 5-7. Example 7

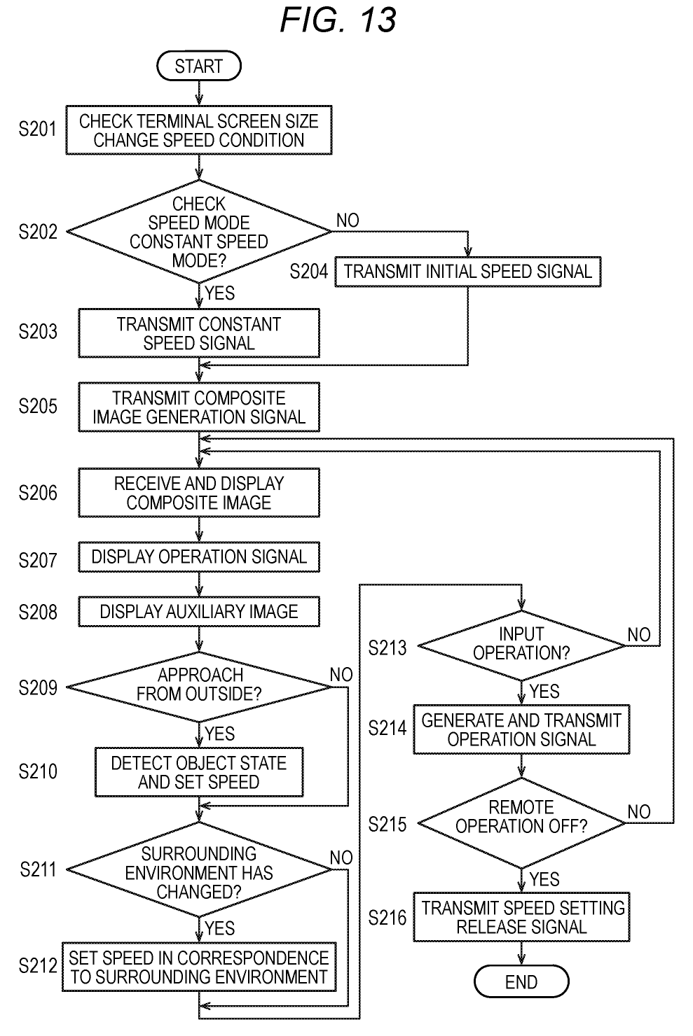

FIG. 13 is a flowchart depicting an example of a processing flow about the vehicle remote operation in Example 7. In Example 7, the processing about the vehicle remote operation that is to be executed by the portable terminal 1 is described with reference to the processing flow of FIG. 13. In the meantime, the description of processing that is common to the processing of FIG. 6 described in Example 1 may be omitted.

The portable terminal 1 is operated by the user, for example, and starts the processing about the remote operation of the vehicle 5 when an instruction to start the remote operation is received from the operation unit 12 (“START” in FIG. 13). The remote operation of the vehicle 5 starts in a state where the vehicle 5 is stopped.

Then, the portable terminal 1 checks a screen size of the display 11, and changes a speed condition of the vehicle 5 during the remote operation relating to the flow, based on the screen size of the display 11 (step S201). The information about the screen size of the display 11 is stored in advance in the storage 17 and the like. For example, the larger the screen size of the display 11 is, the user can more easily check the surrounding situation of the vehicle 5, so that the upper limit of the traveling speed of the vehicle 5 increases.

Then, the portable terminal 1 checks a speed mode of the vehicle 5 and determines whether the speed mode is a constant speed mode (step S202). For example, the speed mode of the vehicle 5 includes a constant speed mode, and a variable mode.

In the constant speed mode, when an icon relating to a traveling direction of the vehicle 5 is operated, the vehicle 5 is controlled so that it travels at constant speed in the corresponding direction. In the meantime, the traveling speed of the vehicle 5 in the constant speed mode can be appropriately arbitrarily set before the icon relating to the traveling direction is operated.

In the variable mode, it is necessary to instruct a traveling direction of the vehicle 5 and to adjust a traveling speed of the vehicle. For example, when the user operates an icon relating to adjustment of the traveling speed while operating the icon relating to the traveling direction, the vehicle 5 is enabled to travel at the adjusted traveling speed in the instructed direction, based on the operations. Specifically, for example, when the user operates an icon relating to speed-up while operating the icon relating to forward movement, the vehicle 5 moves forward with gradually increasing the speed.

Also, the traveling direction, traveling distance, traveling speed and the like of the vehicle 5 may be controlled on the basis of the operation accompanied by movement, such as drag, flick and the like on the touch panel (operation unit 12). Also, a configuration where the vehicle 5 is enabled to travel only for a time period in which the user pushes the icon relating to the traveling of the vehicle 5 and the vehicle 5 is stopped when the user detaches the finger from the icon is also possible.

Also, a configuration where when the user pushes (taps) the icon relating to the traveling of the vehicle 5 one time, the vehicle 5 is enabled to travel by a predetermined distance is also possible. In this case, icons for which long and short traveling distances are preset may be respectively provided.

The setting indicating whether the speed mode of the vehicle 5 is the constant speed mode or the variable mode may be preset or may be selected in the corresponding step by the user.

When the speed mode of the vehicle 5 is the constant speed mode (Yes in step S202), the portable terminal 1 transmits a control signal relating to the constant speed mode to the vehicle control device 3 (step S203). When the speed mode of the vehicle 5 is the variable mode, not the constant speed mode (No in step S202), the portable terminal 1 transmits an initial speed signal relating to the variable mode to the vehicle control device 3 (step S204). The initial speed of the vehicle 5 with respect to the variable mode is preset and stored in the storage 17 and the like. Thereafter, in the variable mode, the user can appropriately arbitrarily change the traveling speed of the vehicle 5.

Then, the portable terminal 1 transmits a control signal relating to the generation of the composite image to the image processing device 2 of the vehicle 5 (step S205). Continuously, the portable terminal 1 receives the composite image from the image processing device 2, and displays the composite image on the display 11 (step S206). Continuously, the portable terminal 1 displays the icons and the like (operation unit 12), which are functional images relating to the operation of the vehicle 5, on the display 11 with superimposing the same on the composite image (step S207). Continuously, the portable terminal 1 displays the auxiliary image on the display 11 (step S208).

Then, a person, an animal, a vehicle and other objects approaching the vehicle 5 from the outside are checked in the vehicle 5 by using the sensor unit 51 or the imaging unit 4, and it is determined whether the approach of the objects is detected (step S209). For example, when the control signal relating to the generation of the composite image is received from the portable terminal 1 and the start of the remote operation by the portable terminal 1 is thus confirmed, a monitoring mode is activated in the vehicle 5, so that monitoring of the approach to the vehicle 5 from the outside is started. The detection of a person, an animal, a vehicle and other objects in the vicinity of the vehicle 5 is determined on the basis of detection signals of the ultrasonic sensor, optical sensor and radar of the sensor unit 51 or image recognition by the captured images of the in-vehicle cameras 41 to 44, for example.

When the approach to the vehicle 5 from the outside is detected (Yes in step S209), a state of the object approaching the vehicle 5 is detected, and the traveling speed of the vehicle 5 is set on the basis of the state of the object (step S310). Specifically, for example, the state of the object includes a distance between the vehicle 5 and the object, a moving speed of the object, and the like. For example, as the distance between the vehicle 5 and the object is shortened, the traveling speed of the vehicle 5 is decreased. Also, for example, when the distance between the vehicle 5 and the object becomes a predetermined distance or shorter, the vehicle 5 is stopped. Also, for example, as the moving speed of the object increases, the traveling speed of the vehicle 5 is decreased.

Then, the surrounding environment of the vehicle 5 is checked in the vehicle 5 by using the sensor unit 51 or the imaging unit 4 (step S211). For example, when the control signal relating to the generation of the composite image is received from the portable terminal 1 and the start of the remote operation by the portable terminal 1 is thus confirmed, the monitoring mode is activated in the vehicle 5, so that monitoring of the surrounding environment of the vehicle 5 is started. The detection of the surrounding environment of the vehicle 5 is determined on the basis of the detection signals of the illuminance sensor, vibration sensor, and inclination sensor of the sensor unit 51 or image recognition by the captured images of the in-vehicle cameras 41 to 44, for example.

Then, the traveling speed of the vehicle 5 is set on the basis of the surrounding environment of the vehicle 5 (step S212). Specifically, for example, the surrounding environment of the vehicle 5 includes brightness, inclination of the vehicle 5, a road surface state, a size of a parking space, a distance to the parking space and the like. For example, as the surrounding of the vehicle 5 becomes darker, the traveling speed of the vehicle 5 is decreased. Also, for example, as the inclination of the vehicle 5 increases, the traveling speed of the vehicle 5 is decreased. Also, for example, when a slippery state such as freezing is detected on the road surface, the traveling speed of the vehicle 5 is decreased. Also, for example, as the parking space becomes narrower and as the distance to the parking space becomes shorter, the traveling speed of the vehicle 5 is decreased. On the other hand, as the parking space becomes wider and the distance to the parking space becomes longer, the traveling speed may be set to be slightly high in an initial stage of the traveling start of the vehicle 5.

Then, the portable terminal 1 determines whether there is the user's operation input to the operation unit 12 (step S213). When there is the operation input to the operation unit 12 (Yes in step S213), the portable terminal 1 generates a control signal of the vehicle 5 on the basis of the operation on the operation unit 12 and transmits the control signal to the vehicle control device 3 (step S214). Continuously, the portable terminal 1 determines whether the user has performed an OFF operation of the remote operation of the vehicle 5 OFF (step S215).

When the user has performed the OFF operation of the remote operation (Yes in step S215), the portable terminal 1 transmits a control signal for speed setting release to the vehicle control device 3 of the vehicle 5 (step S216). Thereby, the traveling speed of the vehicle 5 set during the remote operation of this processing flow is released. Then, the processing flow shown in FIG. 13 is over.

According to the configuration of the portable terminal 1, when performing the remote operation of the vehicle 5, the traveling speed of the vehicle 5 is automatically set on the basis of the state of the object approaching the vehicle 5 and the surrounding environment of the vehicle 5. For example, the traveling speed of the vehicle 5 is decreased depending on the situations, so that the safety upon the remote operation is increased. Accordingly, it is possible to improve the convenience of the remote operation of the vehicle 5.

Specifically, for example, as the distance between the vehicle 5 and object becomes shorter and as the moving speed of the object increases, the traveling speed of the vehicle 5 is decreased, so that it is possible to easily avoid the contact between the vehicle 5 and the object. Also, for example, as the screen size of the display 11 becomes larger, the upper limit of the traveling speed of the vehicle 5 increases, so that it is possible to increase the moving speed of the vehicle 5 by the remote operation. Also, for example, as the surrounding of the vehicle 5 becomes darker, as the inclination of the vehicle 5 increases, and when the slippery state is detected on the road surface, the traveling speed of the vehicle 5 is decreased, so that it is possible to easily avoid the contact between the vehicle 5 and the obstacle and the like around the vehicle. Also, for example, as the parking space becomes narrower, and as the distance to the parking space becomes shorter, the traveling speed of the vehicle 5 is decreased, so that it is possible to easily avoid the contact between the vehicle 5 and the other vehicle and the like. Also, for example, as the parking space becomes wider, and as the distance to the parking space becomes longer, the traveling speed of the vehicle 5 is increased, so that it is possible to increase the moving speed of the vehicle 5 by the remote operation.

### 6. Others

The diverse technical features disclosed in the specification can be diversely changed without departing from the gist of the technical original, in addition to the illustrative embodiment. That is, the illustrative embodiment is exemplary in every respect and should not be construed as being limited. The technical scope of the present disclosure is defined in the claims, not the description of the illustrative embodiment, and includes all changes within the meaning and scope equivalent to the claims. Also, the plurality of illustrative embodiments, examples and modified embodiments can be implemented with being combined within the possible range.

Also, it has been described in the illustrative embodiment that the diverse functions are implemented in a software manner by the calculation processing of the CPU in accordance with the programs. However, some of the functions may be implemented by an electrical hardware circuit. To the contrary, some of the functions to be implemented by the hardware circuit may be implemented in a software manner.

What is claimed is:

1. A vehicle remote operation device comprising:
a communication unit configured to receive a composite image, which is to be generated on the basis of a plurality of captured images captured at each of a plurality of in-vehicle cameras mounted to a vehicle and shows a surrounding area of the vehicle seen from a virtual view point;
a display configured to display the composite image;
an operation unit for operating the vehicle, and
a signal generation unit configured to generate a control signal of the vehicle, based on an operation on the operation unit,
wherein the display is configured to display the composite image having an image of the operation unit superimposed thereon and an auxiliary image comprising a state of the vehicle.

2. The vehicle remote operation device according to claim 1, wherein the operation unit is arranged in correspondence to a position and a direction of an image of the vehicle in the composite image.

3. The vehicle remote operation device according to claim 1, wherein as the auxiliary image, an image comprising an image to be reflected on a mirror of the vehicle is displayed.

4. The vehicle remote operation device according to claim 1, wherein as the auxiliary image, an image of an operating state of the vehicle is displayed.

5. The vehicle remote operation device according to claim 1, wherein as the auxiliary image, an object approaching the vehicle is displayed.

6. The vehicle remote operation device according to claim 1, wherein as the auxiliary image, a captured image obtained by capturing the lower of the vehicle is displayed.

7. The vehicle remote operation device according to claim 1, wherein as the auxiliary image, information about contact between the vehicle and other object around the vehicle is displayed.

8. The vehicle remote operation device according to claim 1,
wherein the auxiliary image comprises an image of the vehicle,
wherein the operation unit is arranged with being superimposed on the auxiliary image, based on a position and a direction of an image of the vehicle in the auxiliary image, and
wherein the signal generation unit is configured to generate a control signal of the vehicle, based on an operation on the operation unit in the auxiliary image.

9. A vehicle remote operation system comprising:
the vehicle remote operation device according to claim 1;
an image processing device configured to generate the composite image showing a surrounding area of the vehicle seen from a virtual view point, on the basis of a plurality of captured images captured at each of the plurality of in-vehicle cameras mounted to the vehicle, and to transmit the composite image to the vehicle remote operation device, and
a vehicle control device configured to receive a control signal of the vehicle from the vehicle remote operation device and to control the vehicle on the basis of the control signal.

10. A vehicle remote operation method comprising:
receiving a composite image, which is to be generated on the basis of a plurality of captured images captured at each of a plurality of in-vehicle cameras mounted to a vehicle and shows a surrounding area of the vehicle seen from a virtual view point;
displaying, on a display, the composite image and an auxiliary image comprising a state of the vehicle;
superimposing an image of an operation unit for operating the vehicle on at least one of the composite image and the auxiliary image;
receiving an operation of the vehicle from the operation unit;
generating a control signal of the vehicle, based on the operation, and
transmitting the control signal to the vehicle.
